(19) United States
(12) Patent Application Publication
(10) Pub. No.: US 2023/0044181 A1
(43) Pub. Date: Feb. 9, 2023

(54) BEAM SPLITTER ARRANGEMENT FOR OPTOELECTRONIC SENSOR, OPTOELECTRONIC SENSOR HAVING SAME, AND METHOD OF BEAM SPLITTING IN AN OPTOELECTRONIC SENSOR

(71) Applicant: SICK AG, Waldkirch (DE)

(72) Inventors: Boris BALDISCHWEILER, Waldkirch (DE); Christoph MENZEL, Waldkirch (DE)

(21) Appl. No.: 17/880,932

(22) Filed: Aug. 4, 2022

(30) Foreign Application Priority Data
Aug. 9, 2021 (DE) 102021120698.7

(51) Int. Cl. G01S 17/10; G01S 7/4865; G02B 27/10; G02B 6/122

(52) U.S. Cl. CPC G01S 17/10; G01S 7/4865; G02B 27/10; G02B 6/1225

(57) ABSTRACT

A beam splitter arrangement for an optoelectronic sensor, an optoelectronic sensor having such a beam splitter arrangement, and a method of beam splitting in an optoelectronic sensor are provided, wherein the beam splitter arrangement has at least one input for coupling first transmitted light beams having first transmitted light pulses into the beam splitter arrangement. At least one beam splitter splits the first transmitted light beams into a plurality of second transmitted light beams having second transmitted light pulses. The beam splitter arrangement further has a plurality of outputs for decoupling the second transmitted light beams from the beam splitter arrangement, with the number of outputs being greater than the number of inputs. Optical compression paths that compress the second transmitted light pulses such that a second pulse length of the second transmitted light pulses is shorter than a first pulse length of the first transmitted light pulses are arranged downstream of at least one beam splitter.

The invention relates to a beam splitter arrangement for an optoelectronic sensor, to an optoelectronic sensor having a beam splitter arrangement, and to a method of beam splitting in an optoelectronic.

Many optoelectronic sensors work in accordance with the scanning principle in which a light ray is transmitted into the monitored zone and the light beam reflected by an object is received again in order then to electronically evaluate the received signal. The time of flight is here often measured using a known phase method or pulse method to determine the distance of a sensed object. This method is also called LIDAR (light detection and ranging).

To expand the measured zone, the scanning beam can be moved, on the one hand, as is the case in a laser scanner. A light beam generated by a laser there periodically sweeps over the monitored zone with the help of a deflection unit. In addition to the measured distance information, a conclusion is drawn on the angular location of the object from the angular position of the deflection unit and the site of an object in the monitored zone is thus detected in two-dimensional polar coordinates.

Another possibility for extending the measured zone comprises simultaneously detecting measured points using a plurality of scanning beams. This can also be combined with a laser scanner that then does not only detect a monitored plane, but also a three-dimensional spatial zone via a plurality of monitored planes.

An optoelectronic multiplane sensor for monitoring a three-dimensional spatial zone is known from EP 1 927 867 B1. The sensor has a plurality of image sensors spaced apart from one another. A light source can be associated with each image sensor and a distance can be determined via a pulse time of flight or by a phase process with its aid. The multiplane sensor is basically set up as a multiplication of individual plane sensors and is thereby relatively bulky.

The scanning movement is achieved by a rotating mirror in most laser scanners. Particularly on the use of a plurality of scanning beams, however, it is also known in the prior art to instead have the total measurement head with the light sources and light receivers rotate, as is described, for example, in DE 197 57 849 B4.

In all the described cases of multiple scanning, a light source is required that generates a plurality of light beams having sufficient power and beam quality. The known solutions in which only single-beam transmission modules are replicated are too complex, however.

DE 10 2004 014 041 A1 discloses a sensor system for obstacle recognition in which a sensor head rotates about its axis. A laser array having a plurality of single lasers that is imaged on the environment via an optics is located in the sensor head.

The devices indicated use either a plurality of light sources or one light source whose light beam scans the monitored zone by movement of the light source itself or with the aid of movable optics such as rotating mirrors to scan an expanded monitored zone. The use of a plurality of light sources as a rule means increased space requirements for the sensor. Movable optical arrangements can, for example, be susceptible toward vibrations, which can be disadvantageous on a use in a mobile deployment in vehicles.

One possibility for beam deflection without moving arrangements is, for example, the use of so-called optical phased arrays (OPAs) such as are described, for example, in DE 10 2017 222 864 A1 or U.S. Pat. No. 2,016,139 266 A1. In addition to the above-named uses for beam deflection or beam control, optical phased arrays are used, for example, for optical free beam communication applications.

The principles of phased arrays are known from radar technology in which a plurality of antennas are controlled in different phasings. A strong directivity of the total wave field that can be pivoted in dependence on the control of the antennas is produced by the superposition of the electromagnetic waves of the individual antennas. In the optical phased array, optical waveguides in which the transmitted light is conducted are used as the antenna feed. The antennas are accordingly formed by optical radiation elements associated with the waveguide outlets, with phase shifting elements respectively being connected upstream of the radiation elements.

The phased array technique requires a coherent superposition of the transmitted light transmitted from the radiation elements so that the radiation elements require a common light source. The transmitted light transmitted from the common light source is as a rule distributed over the different radiation elements or the phase shifters connected upstream in a beam splitter arrangement. In this process, the input of the beam splitter arrangement as a rule limits the power density of the transmitted light pulses to be coupled.

The implementation of the beam splitter arrangement typically takes place in the form of integrated circuits that are designed, for example, as a silicon on insulator (SOI) structure. Different material systems are used here that each have different maximum power densities that can, for example, be dependent on the refractive index, the mode field diameter, the fundamental mode (single mode waveguide), and band gaps (absorption edge). The light guidance takes place in the transparency range, that is remote from the absorption edge. Power densities that cause two photon absorption or other nonlinear processes to be become relevant are, however, already reached at small transmitted light powers (for example 100 mW for a silicon on insulator waveguide) due to the dimensions of the waveguides and the mode field diameters. Two photon absorption is particularly critical here since it results in free charge carriers and thus strong linear absorption with the consequence of material destruction. The peak powers are critical with pulsed transmitted light here, with long pulse break behaviors also not providing any advantage.

The beam splitter arrangement is typically implemented by “1 on 2” beam splitters arranged cascaded in a plurality of planes so that the power density is halved after every plane of the beam splitter arrangement. The problem of maximum power densities is known so that a boosting of the light power by means of a so-called semiconductor optical amplifier (SOA) is proposed behind or in the beam splitter arrangement in the prior art. These amplifiers are, however, active components, require an energy supply, and generate thermal losses. They must have the same amplification in all the branches of the beam splitter arrangement and must absolutely maintain the same amplification and the phase relationship between the individual part beams.

It is known to implement beam splitter arrangements in materials having a greater band gap or smaller refractive index differences and thus larger mode field diameters (for example by using SiN or Si3N4 structures instead of SOI structures) and to subsequently carry out the coupling of the outputs of the beam splitter arrangement into integrated optical circuits on the basis of silicon on insulator (SOI) structures advantageous for optical phased arrays. Coupling losses at the coupling point between the beam splitter arrangement and the optical phased array and the use of different material systems are disadvantageous in such a technical implementation.

Since the power of transmitted light pulses in beam splitters based on silicon on insulator structures is limited to 100 mW without further measures, optical phased arrays have previously only been used in conjunction with continuous wave (CW) light sources. The implementation of an optoelectronic sensor that works in accordance with a direct time of flight (dToF) has thus, for example, not yet been practical with optical phased arrays due to the power limit. To be able to utilize the advantages of a dToF method, pulses having peak powers are necessary that have not been able to be implemented to date due to the power density limitation at the inlet of a beam splitter arrangement based on silicon on insulator structures.

It is therefore the object of the invention to provide an improved beam splitter arrangement in particular for an optoelectronic sensor.

This object is satisfied by a beam splitter arrangement for an optoelectronic sensor, by an optoelectronic sensor having such a beam splitter arrangement, by a method of beam splitting in an optoelectronic sensor.

The invention starts from the basic idea of reducing the power density of first transmitted light pulses of a first transmitted light beam by a controlled pulse stretching such that a nondestructive coupling into a beam splitter arrangement is made possible and of also providing a plurality of second transmitted light beams by a subsequent pulse compression in and/or after the beam splitter arrangement, with a pulse length of the second transmitted light pulses being shorter than the pulse length of the first transmitted light pulses of the first transmitted light beam coupled into the beam splitter arrangement.

The input pulse powers and thus also the output pulse powers of a beam splitter arrangement can be considerably increased by means of the invention, in particular on a use in an optical phased array.

The device in accordance with the invention and the method in accordance with the invention are here based on the method of so-called chirped pulse amplification (CPA) previously not associated with beam splitter arrangement for optoelectronic sensors. Chirped pulse amplification is used, for example, to generate ultrashort laser pulses in the femtosecond range, with a diffraction limiting or bandwidth limiting output pulse first being stretched, subsequently amplified, and then recompressed. The pulse stretching is used here to reduce the power densities in the amplifying medium.

The stretching of the pulse in the time period takes place by imparting a parabolic phase in the frequency space—a naturally occurring process in light propagation in dispersive media in which the refractive index depends on the frequency or on the wavelength of light. A distinction is made here between the generally low material dispersion (refractive index of the material) and the geometric or waveguide dispersion (effective index of the waveguide modes) in waveguides that is generally a lot more pronounced and can be both positive and negative—important for compression and stretching—with respect to the grouped velocity dispersion (GVD) responsible for the pulse stretching and/or pulse compression. This pulse stretching with respect to the bandwidth limited pulse is known as a chirp of the pulse since the low frequency (red) portions of the pulse rush forward while the high frequency (blue) portions lag behind (or vice versa depending on the sign of the dispersion). The power density of the pulse is correspondingly lowered by the extension of the pulse. The pulse can be recompressed and the power density thus increased using a medium having an opposite grouped velocity dispersion.

Based on this, the beam splitter arrangement in accordance with the invention first has at least one input for coupling a first transmitted light beam having first transmitted light pulses into the beam splitter arrangement and a plurality of outputs for decoupling second transmitted light beams having second transmitted light pulses from the beam splitter arrangement, with the number of outputs being greater than the number of inputs. The beam splitter arrangement has at least one beam splitter having one beam splitter input and a plurality of beam splitter outputs to distribute the first transmitted light pulses over the outputs. A respective optical compression path is arranged downstream of the beam splitter outputs of at least one beam splitter. The optical compression paths compress the second transmitted light pulses such that a pulse length of the second transmitted light pulses is shorter than a pulse length of the coupled first transmitted light pulses.

The optical compression paths can preferably be designed as resonant structured waveguides. The dispersion in the waveguide can be set in a controlled manner by a suitable coordination of the structure dimensions to the wavelength of the transmitted light. The grouped velocity dispersion, in particular close to resonance, can hereby be considerably increased so that the length of the optical compression paths required for the pulse compression is in the cm range or mm range. The optical compression paths can thus be designed together with the beam splitters as an integrated optical circuit.

The structuring of the waveguides of the optical compression path can preferably be periodic and particularly preferably have characteristic periods or intervals in the subwavelength range. Scatter losses, that is the coupling of the waveguide mode to radiation modes outside the waveguide is suppressed. On a use of purely dielectric materials, the propagation in the waveguide can thus take place almost loss-free.

The resonant structured waveguides can be designed, for example, as slow light photonic crystal waveguides, as so-called metawaveguides having structures in the subwavelength range, or also as a combination of these waveguide types.

A plurality of beam splitters can be arranged cascaded in a plurality of planes to distribute the coupled transmitted light beam over a plurality of outputs of the beam splitter arrangement, with the respective outputs of a beam splitter being able to be connected to the inputs of following beam splitters. On the use of beam splitters that split an input beam into two output beams, 2ⁿ outputs are thus obtained with n planes. Each plane can have optical compression paths that are arranged downstream of the outputs of the beam splitters of the respective plane. In a preferred embodiment, only the last plane has optical compression paths that are arranged downstream of the outputs of the beam splitters of the last plane. The beam splitter arrangement can preferably be configured as an integrated optical circuit.

In an embodiment of the invention, at least one optical stretching path for stretching the first transmitted light pulses can be arranged upstream of the input of the light beam arrangement. Light pulses that are emitted from a power source and whose power density is too high for a coupling into the beam splitter arrangement can thereby first be stretched.

The optical stretching path has at least one optical fiber and/or an optical grating and/or a prism for the pulse stretching. Such optical stretching paths are known from short pulse laser technology, for example. The grouped velocity dispersion of the optical stretching path can be positive or negative; typical factors for pulse stretching are in the range from 10 to 100 so that the power amplitude is also reduced by a factor of 10 to 100. The optical compression paths in the beam splitter arrangement have a grouped velocity dispersion opposite the grouped velocity dispersion of the optical stretching path for the pulse compression so that a recompression takes place in the beam splitter arrangement or at its end.

The stretching of the transmitted light pulses can also take place in the light source, for example by using so-called chirped semiconductor lasers or fiber lasers that have an optical fiber for pulse stretching. Such laser sources already emit chirped, that is stretched, laser pulses so that an optical stretching path arranged upstream of the beam splitter arrangement can be dispensed with. The grouped velocity dispersion of the optical compression paths in the beam splitter arrangement is then coordinated with the pulse widths and the chirp of the emitted transmitted light pulses so that the optical compression paths can recompress the transmitted light pulses after a beam splitting.

Phase shifting elements for influencing a phase shift of the transmitted light pulses or of the transmitted light beams with respect to one another can be arranged downstream of the outputs of the beam splitter arrangement. The beam splitter arrangement with the phase shifting elements then forms an optical phased array by which a propagation direction of a wavefront generated by superposition of the transmitted light beams can be controlled in a known manner and thus a scanning of a monitored zone can take place. A control unit here controls the phase shifting elements such that they impart the phase shift required for a desired propagation direction of the wavefront onto the transmitted light beams.

The phase shifting elements are preferably configured as an integrated optical circuit. The beam splitters, compression paths, and phase shifting elements are particularly preferably combined in an integrated optical circuit.

So-called semiconductor optical amplifiers (SOAs) known in principle from the prior art can be arranged in the beam splitter arrangement or downstream of the beam splitter arrangement. A further boosting of the light power of the split transmitted light pulses is thus possible.

The beam splitter arrangement in accordance with the invention can preferably be used in an optoelectronic sensor for detecting objects in a monitored zone. Such a sensor preferably comprises at least one light source for transmitting first transmitted light beams having first transmitted light pulses and a beam splitter arrangement in accordance with the invention arranged downstream of the light source. A transmission optics projects the second transmitted light beams into the monitored zone. A light receiver having a reception optics arranged upstream generates received signals from the light beams remitted at objects in the monitored zone and a control and evaluation unit is configured to determine a distance of the object using a time of flight between a transmission of the transmitted light beams and a reception of the remitted light beams.

A spatially resolving area detector, preferably a matrix of photodiodes or APDs (avalanche photodiodes) or also an image sensor having correspondingly associated individual pixels or pixel groups, can be provided for the detection of the light beams remitted by objects from the monitored zone. A further conceivable embodiment provides a SPAD (single-photon avalanche diode) receiver having a plurality of SPADs.

The control and evaluation unit can be connected to the light source, to the beam splitter arrangement, and to the detector and is preferably configured to measure the time of flight between the transmission of the light beams and the reception of the remitted light beams and thus to determine a distance of an object in the monitored zone in particular using a known phase method or pulse method. The sensor thereby becomes distance measuring. Alternatively, only the presence of an object can be determined and output as a switching signal, for example.

The outputs of the beam splitter arrangement can be arranged two-dimensionally in a matrix. A two-dimensional monitored zone can thus be scanned.

The control of the phase shifting elements in the beam splitter arrangement by the control unit can take place in dependence on evaluation results of the control and evaluation unit. If the control and evaluation unit, for example, detects an object in the monitored zone, the control and evaluation unit can control the phase shifting elements via the control unit, for example, such that an environment of the detected object is scanned with increased resolution.

The detector can be synchronized with the scanning of the monitored zone to suppress interfering or extraneous light. For example, only the receiver groups or pixel groups of the detector can thus be activated that receive light remitted from the scanned zones of the monitored zone.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

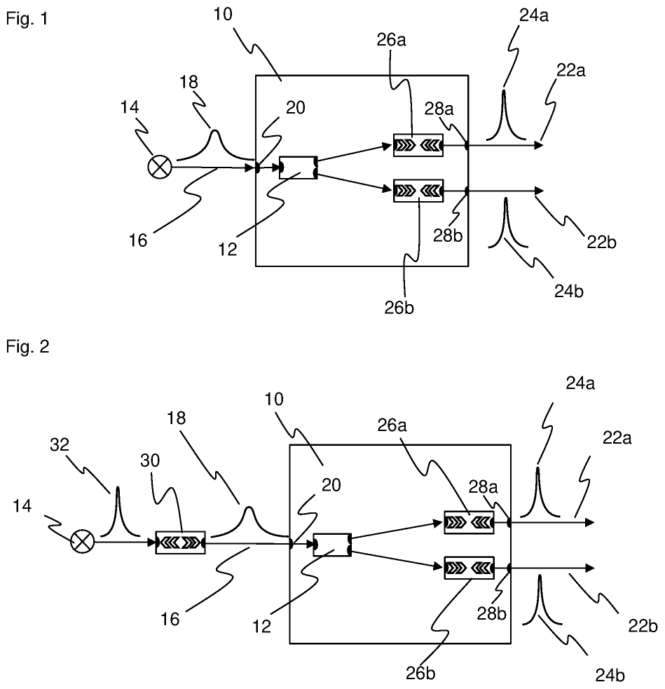

FIG. 1 a schematic representation of an embodiment of the invention;

FIG. 2 a schematic representation of an alternative embodiment of the invention;

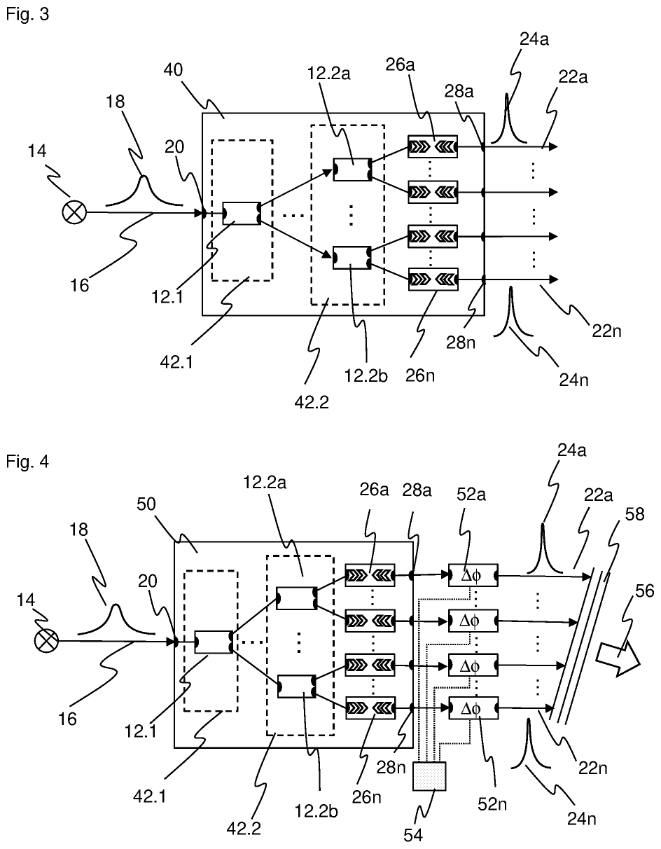

FIG. 3 a schematic representation of an embodiment of the invention with a beam splitter arrangement having beam splitters arranged cascaded;

FIG. 4 a schematic representation of an embodiment of the invention with a beam splitter arrangement configured as an optical phased array; and

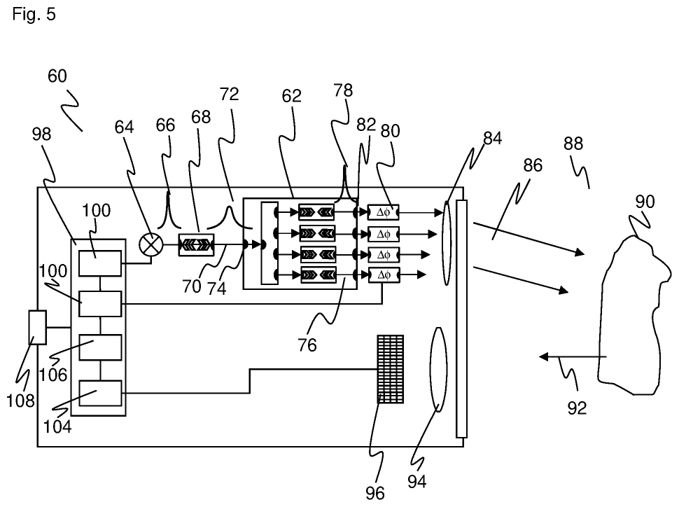

FIG. 5 a schematic representation of an optoelectronic sensor having a beam splitter arrangement in accordance with the invention.

FIG. 1 shows a schematic representation of an embodiment of the invention with a beam splitter arrangement 10, with the beam splitter arrangement 10 having only one beam splitter 12 for reasons of simplicity. A light source 14 emits transmitted light that is coupled as a first transmitted light beam 16 having first transmitted light pulses 18 that have a first pulse length into an input 20 of the beam splitter arrangement 10. The beam splitter 12 splits the first transmitted light beam 16 into two second transmitted light beams 22a, 22b having two second transmitted light pulses 24a, 24b. Two optical compression paths 26a, 26b are arranged downstream of the beam splitter 12 and compress the second transmitted light pulses 24a, 24b such that a pulse length of the second transmitted light pulses 24a, 24b is shorter than the pulse length of the first transmitted light pulses 18. The second transmitted light beams 22a, 22b can be decoupled from the beam splitter arrangement 10 via the outputs 28a, 28b of the beam splitter arrangement 10.

FIG. 2 shows a schematic representation of an alternative embodiment of the invention. Unlike the embodiment shown in FIG. 1, an optical stretching path 28 is arranged upstream of the input 20 of the beam splitter arrangement 10. The transmitted light pulses 30 emitted by the light source 14 cannot be coupled into the beam splitter arrangement due to too high a power density. The transmitted light pulses 32 emitted by the light source 12 are stretched by the optical stretching path 30 so that their power density is reduced. The transmitted light pulses stretched in this manner can then be coupled as first transmitted light pulses 18 into the input 20 of the beam splitter arrangement 10 and can, as in the embodiment shown in FIG. 1, be recompressed after beam splitting to increase the power density.

FIG. 3 shows a schematic representation of an embodiment of the invention with a beam splitter arrangement 40 having beam splitters arranged cascaded. The beam splitter arrangement 40 here has 2 planes 42.1, 42.2 with beam splitters 12.1, 12.2a, 12.2b that each split an input beam into two output beams. The beam splitter arrangement 40 thus generates 4 second transmitted light beams 22a, 22n. As in the above-presented embodiment, a first transmitted light beam 16 having first transmitted light pulses 18 that have a first pulse length is coupled into an input 20 of the beam splitter arrangement 40. On the first plane 42.1 of the beam splitter arrangement 40, a beam splitter 12.1 splits the first transmitted light beam 16 into two transmitted light beams that are split on the second plane 42.2 by two further beam splitters 12.2a, 12.2b into four second transmitted light beams 22a, 22n having second transmitted light pulses 24a, 24n. Four optical compression paths 26a, 26n are arranged downstream of the beam splitters 12.2a, 12.2b of the second plane 42.2 and compress the second transmitted light pulses 24a-24n of the second transmitted light beams 22a, 22n such that a pulse length of the second transmitted light pulses 24a, 24n is shorter than the pulse length of the first transmitted light pulses 18. The second transmitted light beams 22a, 22n can be decoupled from the beam splitter arrangement 40 via the outputs 28a, 28n of the beam splitter arrangement 40.

To compress the transmitted light pulses, optical compression paths can also be arranged between the planes 42.1, 42.2 within the beam splitter arrangement so that a successive pulse compression takes place up to the output of the beam splitter arrangement.

The restriction to 2 planes in the representation of this embodiment is to be understood as purely exemplary. As indicated by the dots between the planes 42.1, 42.2, the beam splitters 12.2a, 12.2b, the optical compression paths 26a, 26n, and the second transmitted light beams 22a, 22n, the beam splitter arrangement can also have more than two planes and can generate correspondingly more transmitted light beams. A beam splitter arrangement can typically have 16-512 outputs for an optoelectronic sensor for object detection.

FIG. 4 shows a schematic representation of a further embodiment of the invention, with, in a further development of the embodiment shown in FIG. 3, phase shifting elements 52a, 52b being arranged downstream of the outputs 28a, 28n of the beam splitter arrangement 50. The phase shifting elements 52a, 52n are controlled via a control unit 54 and are configured to influence phase shifts of the transmitted light beams 22a, 22n with respect to one another. The beam splitter arrangement 50 together with the phase shifting elements 52a, 52n thus forms an optical phased array by which a direction of propagation 56 of a wavefront 58 generated by superposition of the transmitted light beams 22a, 22n can be controlled in a known manner.

FIG. 5 shows a schematic representation of an optoelectronic sensor 60 having a beam splitter arrangement 62 in accordance with the invention. The sensor 60 has a light source 64, for example a laser diode. The tight source 64 emits transmitted light pulses 66 that cannot be directly coupled into the beam splitter arrangement 62 due to too high a power density. The sensor 60 therefore comprises an optical stretching path 68 in which the transmitted light pulses 66 emitted by the light source 64 are stretched so that their power density is reduced. The transmitted light pulses stretched in this manner can then be coupled as first transmitted light beams 70 having first transmitted light pulses 72 into the input 74 of the beam splitter arrangement 62. The first transmitted light beams 70 are, as in the above-described embodiments, split into a plurality of second transmitted light beams 76 having compressed second transmitted light pulses 78 in the beam splitter arrangement 62. Phase shifting elements 80 for influencing the phase shifting of the second transmitted light beams 76 with respect to one another are arranged downstream of the outputs 82 of the beam splitter arrangement 62. The second transmitted light beams 76 can be projected as transmitted light 86 into a monitored zone 88 by a transmission optics 84. The transmitted light remitted by an object 90 in the monitored zone 88 is conducted as received light 92 onto a light receiver 96 via a reception optics 94.

The light receiver 96 is configured as a matrix from a plurality of light reception elements, preferably as a matrix of photodiodes APDs (avalanche photodiodes) or SPAD (single photon avalanche diode) receivers or also as an image sensor having correspondingly associated single pixels or pixel groups.

A control and evaluation unit 98 that is connected to the light source 64, to the beam splitter 62, and to the light receiver 96 is furthermore provided in the sensor 60. The control and evaluation unit 98 comprises a light source control 100, a control unit 102 for the phase shifting elements 80, a time of flight measuring unit 104, and an object distance estimation unit 106, with this initially only being functional blocks that can also be implemented in the same hardware or in other functional units such as in the light source 64, in the beam splitter arrangement 62, or in the light receiver 96. The control and evaluation unit 98 can output measured data via an interface 108 or can conversely accept control and parameterization instructions. The control and evaluation unit 98 can also be arranged in the form of local evaluation structures on a chip of the light receiver 96 or can interact as a partial implementation with the functions of a central evaluation unit (not shown).

1. A beam splitter arrangement for an optoelectronic sensor that has at least one input for coupling first transmitted light beams having first transmitted light pulses into the beam splitter arrangement, at least one beam splitter for splitting the first transmitted light beams into a plurality of second transmitted light beams having second transmitted light pulses, and a plurality of outputs for decoupling the second transmitted light beams from the beam splitter arrangement, with the number of outputs being greater than the number of inputs, characterized in that optical compression paths are arranged downstream of the at least one beam splitter and compress the second transmitted light pulses such that a second pulse length of the second transmitted light pulses is shorter than a first pulse length of the first transmitted light pulses.

2. The beam splitter arrangement in accordance with claim 1, wherein the optical compression paths are configured as resonant structured waveguides.

3. The beam splitter arrangement in accordance with claim 2, wherein the resonant structured waveguides are slow light photonic crystal waveguides.

4. The beam splitter arrangement in accordance with claim 1, wherein the beam splitter arrangement has a plurality of beam splitters arranged cascaded.

5. The beam splitter arrangement in accordance with claim 1, wherein the optical compression paths and the beam splitters are combined in an integrated optical circuit.

6. The beam splitter arrangement in accordance with claim 1, wherein at least one optical stretching path for stretching of transmitted light pulses emitted by a light source is arranged upstream of at least one input of the beam splitter arrangement.

7. The beam splitter arrangement in accordance with claim 6, wherein the at least one optical stretching path is configured as an optical fiber and/or an optical grating and/or a prism.

8. The beam splitter arrangement in accordance with claim 1, wherein phase shifting elements for influencing phase shifts of the second transmitted light beams with respect to one another are arranged downstream of the outputs of the beam splitter arrangement.

9. The beam splitter arrangement in accordance with claim 8, wherein the beam splitters, compression paths, and phase shifting elements are combined in an integrated optical circuit.

10. The beam splitter arrangement in accordance with claim 1, wherein semiconductor optical amplifiers for boosting a light power of the second transmitted light pulses are arranged downstream of the at least one beam splitter

11. An optoelectronic sensor for detecting an object in a monitored zone having at least one light source for transmitting transmitted light beams having transmitted light pulses, a beam splitter arrangement arranged downstream of the light source for splitting the transmitted light beams into a plurality of second transmitted light beams, a transmission optics for projecting the second transmitted light beams into the monitored zone as transmitted light, a light receiver having a reception optics arranged upstream for generating received signals from light beams remitted at the object, and a control and evaluation unit for acquiring information on the object from the received signals,
wherein the beam splitter arrangement is configured in accordance with one of the preceding claims.

12. The optoelectronic sensor in accordance with claim 11, wherein the control and evaluation unit is configured to determine a distance of the object from a time of flight between the transmission of the transmitted light and the reception of the light beams remitted by the object.

13. A method of splitting transmitted light beams in an optoelectronic sensor, said method comprising the following steps:
coupling first transmitted light beams having first transmitted light pulses into a beam splitter arrangement;
splitting the first transmitted light beams into a plurality of second transmitted light beams having second transmitted light pulses, with the number of second transmitted light beams being greater than the number of first transmitted light beams, characterized by the further step:
compressing the second transmitted light pulses such that a second pulse length of the second transmitted light pulses is shorter than a first pulse length of the first transmitted light pulses.

14. The method in accordance with claim 13, further comprising the further step:
influencing a phase shift of the second transmitted light beams with respect to one another.
